(19) United States
(12) Patent Application Publication
(10) Pub. No.: US 2017/0330598 A1
(43) Pub. Date: Nov. 16, 2017

(54) METHOD AND SYSTEM FOR CREATING AND USING VIDEO TAG

(71) Applicant: NAVER Corporation, Seongnam-si (KR)

(72) Inventors: Byung Gyou Choi, Seongnam-si (KR); Jae Chul Ahn, Seongnam-si (KR); Song Hyun Park, Seongnam-si (KR)

(21) Appl. No.: 15/227,513

(22) Filed: Aug. 3, 2016

(30) Foreign Application Priority Data
May 10, 2016 (KR) 10-2016-0056937

(51) Int. Cl. G11B 27/19

(52) U.S. Cl. CPC G11B 27/19

(57) ABSTRACT

Provided is a method and system for creating and using a video tag. A method configured as a computer may include creating tagging information by connecting information about at least one partial playback section in an entire playback section of a video to a tag designated by a user; and storing the tagging information in association with the at least one partial playback section instead of storing the at least one partial playback section.

### CROSS-REFERENCE TO RELATED APPLICATION(S)

This application claims priority under 35 U.S.C. §119 to Korean Patent Application No. 10-2016-0056937 filed on May 10, 2016, in the Korean Intellectual Property Office (KIPO), the entire contents of which are incorporated herein by reference.

### BACKGROUND

### Field

One or more example embodiments relate to technology for creating and using a video tag.

### Description of Related Art

A rapid increase in the number of users of a high-speed communication network has enabled the development of new services using a communication network and the diversification of service items. A video providing service may be the most general service among services using a communication network.

### SUMMARY

One or more example embodiments provide a method and a system for creating a video tag by connecting a tag to a portion of scenes that constitute a video.

One or more example embodiments also provide a method and a system for easily sharing a portion of scenes in a video based on tagging information.

One or more example embodiments also provide a method and a system for playing a scene connected to a tag through a tag search.

At least one example embodiment provides a method implemented in a computer, the method including creating tagging information by connecting information about at least one partial playback section in an entire playback section of a video to a tag designated by a user; and storing the tagging information in association with the at least one partial playback section instead of storing the at least one partial playback section.

The creating may include receiving an input or a selection of a tag name in a text form and designating the tag.

The creating may include creating the tagging information by storing a tagging start time and a tagging stop time in the entire playback section of the video in association with the tag, the tagging start time indicating a video playback time corresponding to a point in time at which a tagging start request is input and the tagging stop time indicating a video playback time corresponding to a point in time at which a tagging stop request is input.

The method may further include displaying a menu list including a menu for designating the tag, a menu for the tagging start request, and a menu for the tagging stop request on a video playback screen on which the video is displayed.

The method may further include indicating a tagging mark of a section from the tagging start time to the tagging stop time in the entire playback section of the video on a video playback screen on which the video is displayed.

The method may further include providing a function of initializing or deleting tagging of the section from the tagging start time to the tagging stop time using the tagging mark.

The storing may include storing the tagging information in a local area of the computer or uploading the tagging information to a server that interacts with the computer.

The method may further include sharing the tagging information with another user through a server that interacts with the computer.

The method may further include searching for tagging information corresponding to the tag in response to a search request using the tag, and providing a video playback section connected to the tag as a search result.

The providing may include specifying a video that is a search target and searching for the video playback section connected to the tag in response to the search request.

At least one example embodiment also provides a non-transitory computer-readable medium storing a computer program to implement a video tagging method including creating tagging information by connecting information about at least one partial playback section in an entire playback section of a video to a tag designated by a user; and storing the tagging information in association with the at least one partial playback section instead of storing the at least one partial playback section.

At least one example embodiment also provides a system configured as a computer, the system including a memory to which at least one program is loaded; and at least one processor. Under control of the program, the at least one processor is configured to perform a process of creating tagging information by connecting information about at least one partial playback section in an entire playback section of a video to a tag designated by a user; and a process of storing the tagging information in association with the at least one partial playback section instead of storing the at least one partial playback section.

The creation process may be to receive an input or a selection of a tag name in a text form and to designate the tag.

The creation process may be to create the tagging information by storing a tagging start time and a tagging stop time in the entire playback section of the video in association with the tag, the tagging start time indicating a video playback time corresponding to a point in time at which a tagging start request is input and the tagging stop time indicating a video playback time corresponding to a point in time at which a tagging stop request is input.

Under control of the program, the at least one processor may be configured to further process a process of indicating a tagging mark of a section from the tagging start time to the tagging stop time in the entire playback section of the video on a video playback screen on which the video is displayed.

Under control of the program, the at least one processor may be configured to further process a process of providing a function of initializing or deleting tagging of the section from the tagging start time to the tagging stop time using the tagging mark.

The storage process may be to store the tagging information in a local area of the computer or to upload the tagging information to a server that interacts with the computer.

Under control of the program, the at least one processor may be configured to further process a process of sharing the tagging information with another user through a server that interacts with the computer.

Under control of the program, the at least one processor may be configured to further process a process of searching for tagging information corresponding to the tag in response to a search request using the tag, and providing a video playback section connected to the tag as a search result.

The providing process may be to specify a video that is a search target and to search for the video playback section connected to the tag in response to the search request.

According to some example embodiments, it is possible to easily and simply connect a tag to a portion of scenes that constitute a video.

Also, according to some example embodiments, it is possible to connect an identifiable name to a portion of scenes in a video as a tag, and to search for a desired scene, thereby saving time and effort used for retrieving the scene.

Also, according to some example embodiments, it is possible to provide a highlight scene of a video using a tag that is logical information, instead of providing a highlight image using a segmental image, thereby saving a server storage.

Also, according to some example embodiments, it is possible to quickly share a desired scene in a video by connecting the scene to be shared to a tag and by uploading the scene. Further, it is possible to effectively share a plurality of scenes by sharing a single tag.

Further areas of applicability will become apparent from the description provided herein. The description and specific examples in this summary are intended for purposes of illustration only and are not intended to limit the scope of the present disclosure.

### BRIEF DESCRIPTION OF THE FIGURES

Example embodiments will be described in more detail with regard to the figures, wherein like reference numerals refer to like parts throughout the various figures unless otherwise specified, and wherein:

FIG. 1 illustrates an example of a network environment according to at least one example embodiment;

FIG. 2 is a block diagram illustrating a configuration of an electronic device and a server according to at least one example embodiment;

FIG. 3 is a block diagram illustrating an example of constituent elements includable in a processor of an electronic device according to at least one example embodiment;

FIG. 4 is a flowchart illustrating an example of a video tagging method performed by an electronic device according to at least one example embodiment;

FIG. 5 is a flowchart illustrating an example of a video playback control method performed by a video playback controller according to at least one example embodiment;

FIG. 6 illustrates an example of a video playback screen according to at least one example embodiment;

FIG. 7 is a flowchart illustrating an example of a tag storage method performed by a tag creator according to at least one example embodiment;

FIG. 8 is a flowchart illustrating an example of a tagging information creating method performed by a tag creator according to at least one example embodiment;

FIG. 9 illustrates an example of a user interface screen for creating tagging information of a video according to at least one example embodiment;

FIG. 10 is a flowchart illustrating an example of a tagging information sharing method performed by a tag manager according to at least one example embodiment;

FIG. 11 is a flowchart illustrating an example of a tag search and play method performed by a tag searcher according to at least one example embodiment; and

FIG. 12 illustrates an example of a tag search result screen according to at least one example embodiment.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments.

### DETAILED DESCRIPTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed items. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware, software, and/or a combination thereof. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, example embodiments will be described with reference to the accompanying drawings.

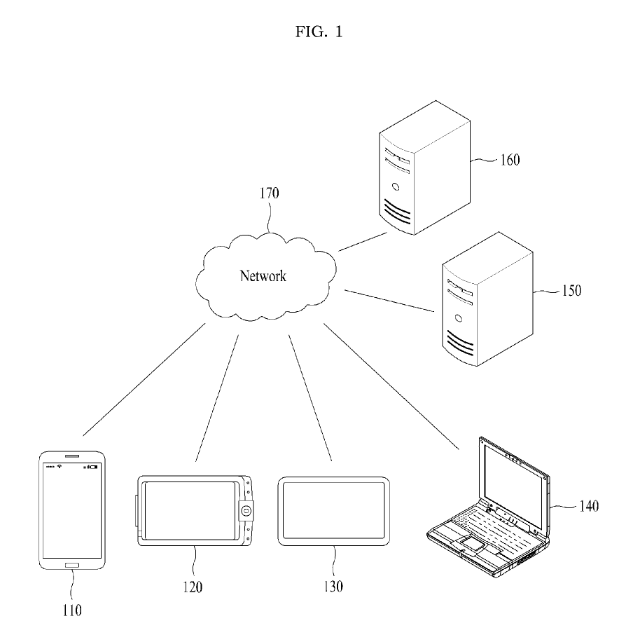

FIG. 1 is a diagram illustrating a network environment according to at least one example embodiment. Referring to FIG. 1, the network environment includes a plurality of electronic devices 110, 120, 130, and 140, a plurality of servers 150 and 160, and a network 170. FIG. 1 is provided as only an example and thus, the number of electronic devices and/or the number of servers are not limited thereto.

Each of the plurality of electronic devices 110, 120, 130, and 140 may be a fixed terminal or a mobile terminal configured as a computer device. For example, the plurality of electronic devices 110, 120, 130, and 140 may be a smartphone, a mobile phone, navigation, a computer, a laptop computer, a digital broadcasting terminal, a personal digital assistant (PDA), a portable multimedia player (PMP), a tablet PC, and the like. For example, the electronic device 110 may communicate with other electronic devices 120, 130, and/or 140, and/or the servers 150 and/or 160 over the network 170 in a wired communication manner or in a wireless communication manner.

The communication scheme is not particularly limited and may include a communication method that uses a near field communication between devices as well as a communication method using a communication network, for example, a mobile communication network, the wired Internet, the wireless Internet, and a broadcasting network. For example, the network 170 may include at least one of network topologies that include networks, for example, a personal area network (PAN), a local area network (LAN), a campus area network (CAN), a metropolitan area network (MAN), a wide area network (WAN), a broadband network (BBN), the Internet, and the like. Also, the network 170 may include at least one of network topologies that include a bus network, a star network, a ring network, a mesh network, a star-bus network, a tree or hierarchical network, and the like. However, it is only an example and the example embodiments are not limited thereto.

Each of the servers 150 and 160 may be configured as a computer apparatus or a plurality of computer apparatuses that provides instructions, codes, file, contents, services, and the like through communication with the plurality of electronic devices 110, 120, 130, and/or 140 over the network 170.

For example, the server 160 may provide a file for installing an application to the electronic device 110 connected over the network 170. In this case, the electronic device 110 may install the application using the file provided from the server 160. The electronic device 110 may use a service and/or content provided from the server 150 by connecting to the server 150 under control of at least one program, for example, browser or the installed application, and an operating system (OS) included in the electronic device 110. For example, in response to a service request message transmitted from the electronic device 110 to the server 150 over the network 170 under control of the application, the server 150 may transmit a code corresponding to the service request message to the electronic device 110. The electronic device 110 may provide content to a user by displaying a code-based screen under control of the application.

As another example, the server 150 may serve to manage all of information of an image, and may include an image database configured to store and maintain an image and a metadata database configured to store and maintain metadata of each image. The server 150 may provide an image and metadata to the electronic device 110 in conjunction with the application installed on the electronic device 110, or may receive and store metadata created at the electronic device 110 under control of the application. As another example, the server 150 may transmit data for a streaming service to the electronic device 110 over the network 170. In this case, the electronic device 110 may play and output a moving picture based on streaming data under control of at least one program and the OS included in the electronic device 110. Also, the server 150 may serve as a service platform including a social network service (SNS) and the like, and may provide a service to a user having requested the service in conjunction with the application installed on the electronic device 110. For example, the server 150 may set a communication session between the electronic devices 110 and 120 connected to the server 150. The electronic devices 110 and 120 may use a service, such as a data transmission, a chat, a voice call, a video call, etc., between the electronic devices 110 and 120 through the set communication session.

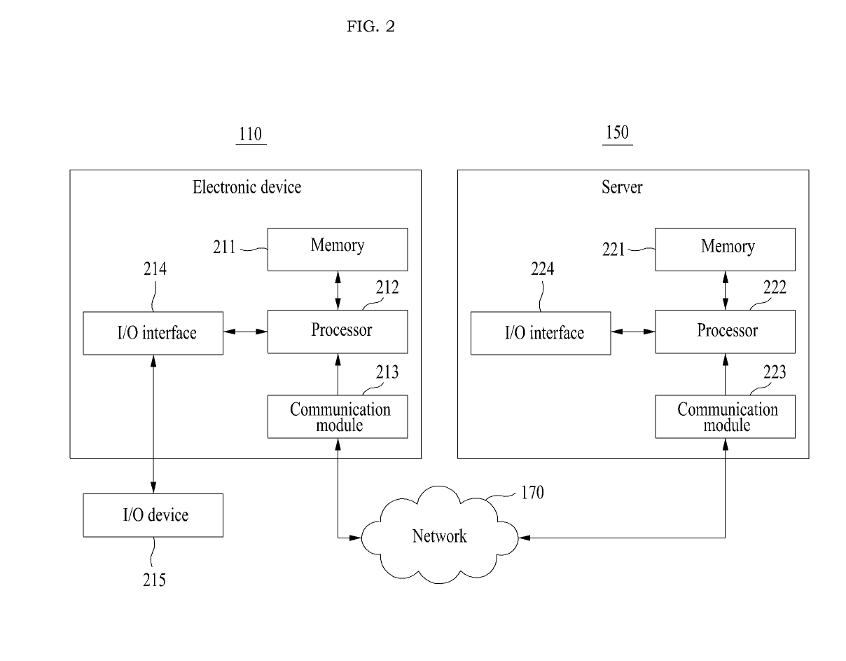

FIG. 2 is a block diagram illustrating a configuration of an electronic device and a server according to at least one example embodiment. FIG. 2 illustrates a configuration of the electronic device 110 as an example for a single electronic device and illustrates a configuration of the server 150 as an example for a single server. The electronic devices 120, 130, and 140, and/or the server 160 may have the same or similar configuration to the electronic device 110 and/or the server 150.

Referring to FIG. 2, the electronic device 110 includes a memory 211, a processor 212, a communication module 213, and an input/output (I/O) interface 214, and the server 150 includes a memory 221, a processor 222, a communication module 223, and an I/O interface 224. The memory 211, 221 may include a permanent mass storage device, such as random access memory (RAM), read only memory (ROM), a disk drive, etc., as a computer-readable storage medium. Also, an OS and at least one program code, for example, the aforementioned code for browser or the application installed and executed on the electronic device 110, may be stored in the memory 211, 221. Such software constituent elements may be loaded from another computer-readable storage medium separate from the memory 211, 221 using a drive mechanism. The other computer-readable storage medium may include, for example, a floppy drive, a disk, a tape, a DVD/CD-ROM drive, a memory card, etc. According to other example embodiments, software constituent elements may be loaded to the memory 211, 221 through the communication module 213, 223, instead of, or in addition to, the computer-readable storage medium. For example, at least one program may be loaded to the memory 211, 221 based on a program, for example, the application, installed by files provided over the network 170 from developers or a file distribution system, for example, the server 160, that provides an installation file of the application.

The processors 212, 222 may be configured to process computer-readable instructions, for example, the aforementioned at least one program code, of a computer program by performing basic arithmetic operations, logic operations, and I/O operations. The computer-readable instructions may be provided from the memory 211, 221 and/or the communication modules 213, 223 to the processors 212, 222. For example, the processors 212, 222 may be configured to execute received instructions in response to the program code stored in the storage device such as the memory 211, 222.

The communication modules 213, 223 may provide a function for communication between the electronic device 110 and the server 150 over the network 170, and may provide a function for communication with another electronic device, for example, the electronic device 120 or another server, for example, the server 160. For example, the processor 212 of the electronic device 110 may transfer a request, for example, a request for a video call service, generated based on a program code stored in the storage device such as the memory 211, to the server 150 over the network 170 under control of the communication module 213. Inversely, a control signal, an instruction, content, file, etc., provided under control of the processor 222 of the server 150 may be received at the electronic device 110 through the communication module 213 of the electronic device 110 by going through the communication module 223 and the network 170. For example, a control signal, an instruction, etc., of the server 150 received through the communication module 213 may be transferred to the processor 212 or the memory 211, and content, a file, etc., may be stored in a storage medium further includable in the electronic device 110.

The I/O interface 214 may be a device used for interface with an I/O device 215. For example, an input device may include a keyboard, a mouse, etc., and an output device may include a device, such as a display for displaying a communication session of an application. As another example, the I/O interface 214 may be a device for interface with an apparatus in which an input function and an output function are integrated into a single function, such as a touch screen. In detail, when processing instructions of the computer program loaded to the memory 211, the processor 212 of the electronic device 110 may display a service screen configured using data provided from the server 150 or the electronic device 120, or may display content on a display through the I/O interface 214.

According to other example embodiments, the electronic device 110 and the server 150 may include a greater or lesser number of constituent elements than the number of constituent elements shown in FIG. 2. However, there is no need to clearly illustrate many constituent elements according to the related art. For example, the electronic device 110 may include at least a portion of the I/O device 215, or may further include other constituent elements, for example, a transceiver, a global positioning system (GPS) module, a camera, a variety of sensors, a database, and the like. In detail, if the electronic device 110 is a smartphone, the electronic device 110 may further include various constituent elements, such as an accelerometer or a gyro sensor, a camera, various physical buttons, a button using a touch panel, an I/O port, a vibrator for vibration, etc., that are generally included in the smartphone.

In the example embodiments, the electronic device 110 may be a device on which a moving picture application is installed, and a video tagging system may be configured in the electronic device 110 through a control instruction provided from the moving picture application. The moving picture application may be a program that is installed on the electronic device 110 and independently controls the electronic device 110, and may be a program that controls the electronic device by additionally using an instruction from the server 150 through communication with the server 150. For example, the moving picture application may be a media player application. In this case, the electronic device 110 may receive moving picture content through the server 150, and may share the moving picture content with another electronic device, for example, the electronic device 120 through the server 150 by storing tagging information created in association with the moving picture content in a local storage or by uploading the tagging information to the server 150. Here, the moving picture application may include functions for creating, uploading, and searching for tagging information. The electronic device 110 may perform a video tagging method using the functions.

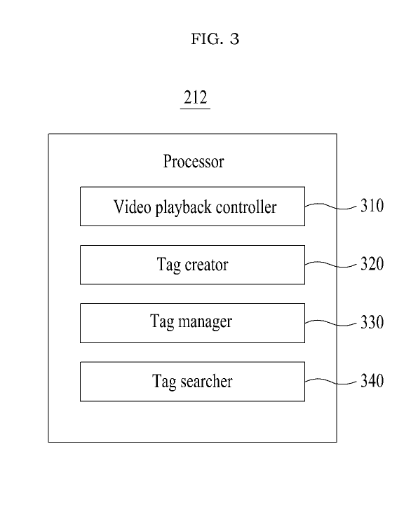

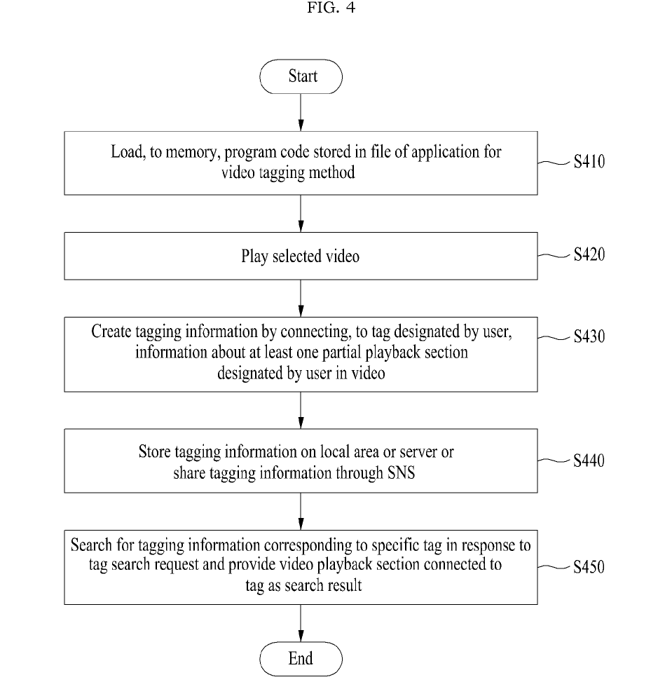

FIG. 3 is a block diagram illustrating an example of constituent elements includable in a processor of the electronic device 110 according to at least one example embodiment, and FIG. 4 is a flowchart illustrating an example of a video tagging method performed at the electronic device 110 according to at least one example embodiment.

Referring to FIG. 3, the processor 212 of the electronic device 110 may include, as constituent units, a video playback controller 310, a tag creator 320, a tag manager 330, and a tag searcher 340. The processor 212 and the units of the processor 212 may control the electronic device 110 to perform operations 5410 through 5450 included in the video tagging method described in FIG. 4. Here, the processor 212 and the constituent elements of the processor 212 may be configured to execute an instruction according to a code of at least one program and a code of the OS included in the memory 211. The at least one program may be the aforementioned moving picture application. Also, the constituent units of the processor 212 may represent different functions performed at the processor 212 in response to a control instruction provided from the moving picture application. For example, the video playback controller 310 may be used as a functional expression that operates when the processor 212 plays a video, such as moving picture content, in response to the control instruction.

In operation 5410, the processor 212 may load, to the memory 211, a program code stored in a file of an application for the video tagging method. For example, the application may be the moving picture application and may include a control instruction for controlling the electronic device 110 to perform the video tagging method. In response to executing the application installed on the electronic device 110, the processor 212 may control the electronic device 110 to load a program code from the file of the application to the memory 221.

Here, the processor 212 and the video playback controller 310, the tag creator 320, the tag manager 330, and the tag searcher 340 included in the processor 212 may be different functional representations of the processor 212 for performing operations 5420 through 5450 by executing a corresponding portion of the program code loaded to the memory 211. The processor 212 and the constituent units of the processor 212 may control the electronic device 110 to perform operations 5420 through 5450. For example, the processor 212 may control the electronic device 110 to play a video, such as moving picture content.

In operation 5420, in response to receiving an instruction for selecting a video, the video playback controller 310 controls the electronic device 110 to play the selected video. For example, the video playback controller 310 may read a list of videos stored in the electronic device 110 and may play and output a video selected from the list of videos. As another example, the video playback controller 310 may play and output a video being streamed through a streaming service provided from the server 150. The video playback controller 310 may control all output associated with the video, for example, output of a representative image, for example, a thumbnail, tagging information, etc. The video playback controller 310 may mark a reference point indicating a current playback time of the video on the representative image, for example, the thumbnail that serves as a kind of progress bar. The video playback controller 310 may output a representative image for each section of the video as an index for seeking a playback section, and may control a section seeking to be performed based on a playback time corresponding to a representative image selected by the user from among the output representative images. That is, it is possible to conduct a search and to seek a playback section of a video using a representative image.

In operation 5430, the tag creator 320 creates tagging information by setting a text designated by the user for the video as a tag and by connecting, to the tag, information about at least one partial playback section designated by the user in the video. The tag creator 320 may connect a plurality of partial playback sections included in a specific video to a single tag, and may connect partial playback sections of different videos to a single tag. The tagging information may include video identification information, for example, a video name, a video ID, etc., tag identification information, for example, a tag name, a tag ID, etc., and time information of a tagged playback section, for example, a section start time and a section end time. Depending on example embodiments, the tagging information may further include a representative image (thumbnail) of the tagged playback section, for example, a first frame of the playback section. A single video may include N tags, and a single tag may include N taggings. That is, the tag creator 320 may create tagging information about the video in a structure in which a plurality of taggings is connected to a single tag.

In operation 5440, the tag manager 330 stores and manages the created tagging information. The tag manager 330 may not store at least one partial playback section designated by the user in an entire playback section of the video as a segmental image, and may store the tagging information created in operation 5430 in association with the corresponding playback section instead of storing the at least one partial playback section designated by the user. The tag manager 330 may overall manage storage, correction, deletion, selection, and the like, of the tagging information. For example, the tag manager 330 may store tagging information created in operation 5430 in association with the video stored in the electronic device 110, in a local area, for example, a file, a database, a memory, etc., of the electronic device 110. As another example, the tag manager 330 may upload the tagging information created in operation 5430 to the server 150 to store on the server 150 in association with the video provided from the server 150. As another example, the tag manager 330 may share the tagging information created in operation 5430 with another user through an SNS, for example, LINE, Twitter, Facebook, etc. The tag manager 330 may enable interaction between the tagging information and the SNS instead of storing the tagging information on the local area of the electronic device 110 or the server 150.

In operation 5450, the tag searcher 340 searches for tagging information corresponding to a specific tag in response to a search request for the tag, and provides a video playback section connected to the tag as a search result. For example, the tag searcher 340 may search a local environment of the electronic device 110 and may provide a tag search result. As another example, the tag searcher 340 may transfer a search request for a specific tag to the server 150, and may receive, from the server 150, a video playback section connected to the tag in response to the search request, and may output the received video playback section as a search result. When conducting a tag search, the tag searcher 340 may specify and thereby search for a video that is a search target and may also conduct a search for all of the videos.

According to example embodiments, it is possible to simply connect a plurality of specific scenes included in a video using a tag. Also, instead of creating a separate image, such as a highlight image, as a segmental image, it is possible to search for or share a plurality of specific scenes connected to a tag.

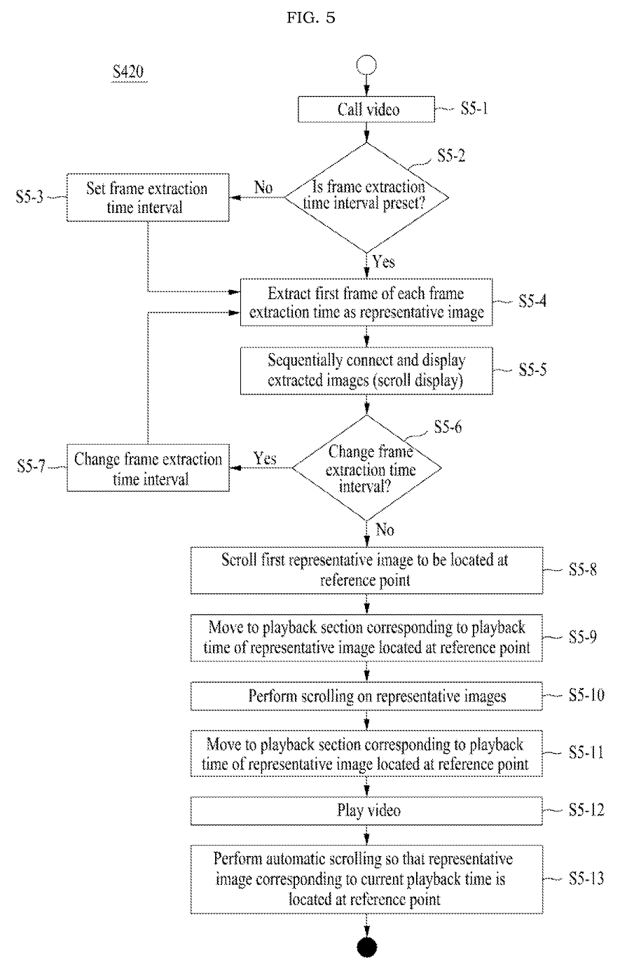

FIG. 5 is a flowchart illustrating an example of a video playback control method performed by the video playback controller 310 according to at least one example embodiment. Operations S5-1 through S5-13 of FIG. 5 may be included in operation 5420 of FIG. 4 and thereby performed.

In operation S5-1, the video playback controller 310 calls a video selected by a user in response to a user instruction for selecting the video.

In operation S5-2, the video playback controller 310 determines whether a frame extraction time interval is preset in the called video.

In operation S5-3, when the frame extraction time interval is not preset in the video, the video playback controller 310 sets the frame extraction time interval for extracting a frame. For example, the video playback controller 310 may equally divide the entire playback time of the video or may arbitrarily determine a unit time interval, for example, one minute as the frame extraction time interval. Also, the video playback controller 310 may determine a time interval set by the user as the frame extraction time interval of the video.

In operation S5-4, when the frame extraction time interval is set, the video playback controller 310 extracts, as a representative image, for example, a thumbnail, a single frame, for example, a first frame from among frames with respect to each frame extraction time interval. For example, if the frame extraction time interval is one minute in a video having 60-minute running time, 60 representative images may be extracted and each representative image may include a 60-second playback section.

In operation S5-5, the video playback controller 310 sequentially connects and displays representative images extracted at frame extraction time intervals as an index for seeking a playback section, on a video playback screen on which the video called in operation S5-1 is played and displayed. Here, the sequentially connected representative images may be displayed in a scrollable form.

In operation S5-6, the video playback controller 310 determines whether a request for changing the frame extraction time interval is present.

In operation S5-7, when the request for changing the frame extraction time interval is present, the video playback controller 310 changes the frame extraction time interval with a requested time interval and determines again the changed time interval as the frame extraction time interval. If the frame extraction time interval of the video is changed, the video playback controller 310 repeats operations S5-4 through S5-6.

On the contrary, in operation S5-8, if the request for changing the frame extraction time interval is absent, the video playback controller 310 scrolls a first representative image to be located at a reference point indicating a video playback time. That is, the reference point may indicate a playback time of an image currently output, that is, displayed on the video playback screen.

In operation S5-9, the video playback controller 310 performs scrolling on a representative image and at the same time, performs playback section seeking based on a playback time corresponding to the representative image located at the reference point.

In operation S5-10, the video playback controller 310 performs scrolling on the sequentially connected representative images according to a user manipulation. Here, a representative image corresponding to a scroll may be located at the reference point.

In operation S5-11, the video playback controller 310 performs playback section seeking based on the playback time corresponding to the representative image that is located at the reference point in response to scrolling performed with respect to the representative image.

In operation S5-12, the video playback controller 310 plays a video by determining a video playback time, and plays and outputs a playback section of the representative image located at the reference point.

In operation S5-13, if the video is consecutively played, the video playback controller 310 performs automatic scrolling so that a representative image corresponding to a current playback time is located at the reference point.

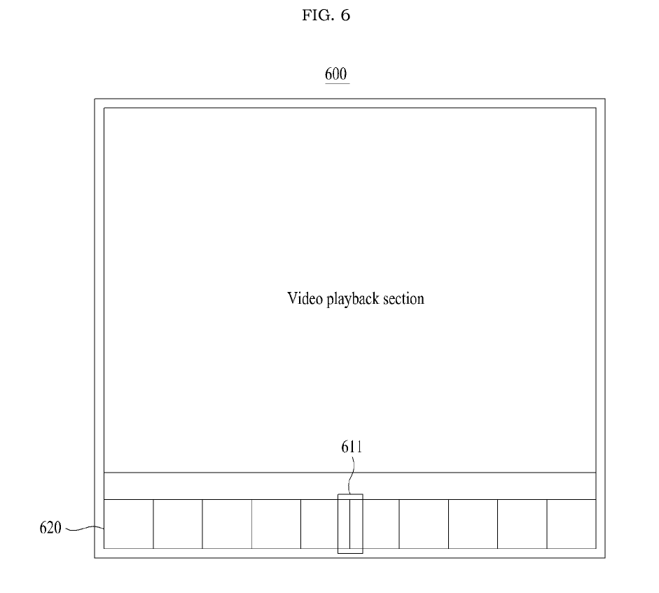

For example, referring to FIG. 6, a representative image list 620 may be displayed on a video playback screen 600 of the electronic device 110, for example. The representative image list 620 may include representative images that are extracted at frame extraction time intervals set to a video. A reference point 611 indicating a current playback time of the video may be marked on the representative image list 620. The representative image list 620 may serve as a thumbnail progress bar, such as a prototype screen. For example, the reference point 611 may be fixed at the center of the representative image list 620. Representative images included in the representative image list 620 may be automatically scrolled to fit the reference point 611 and a current playback time of the video may be indicated according to playing of the video. Auto-scrolling may be performed to locate a first representative image at the reference point 611 at an initial stage, and to subsequently locate a representative image of a section corresponding to a current playback time of the video at the reference point 611.

A process of extracting and displaying a representative image may be selectively performed or omitted in the video playback control method. The representative image list 620 may be selectively configured or omitted on the video playback screen 600 of FIG. 6.

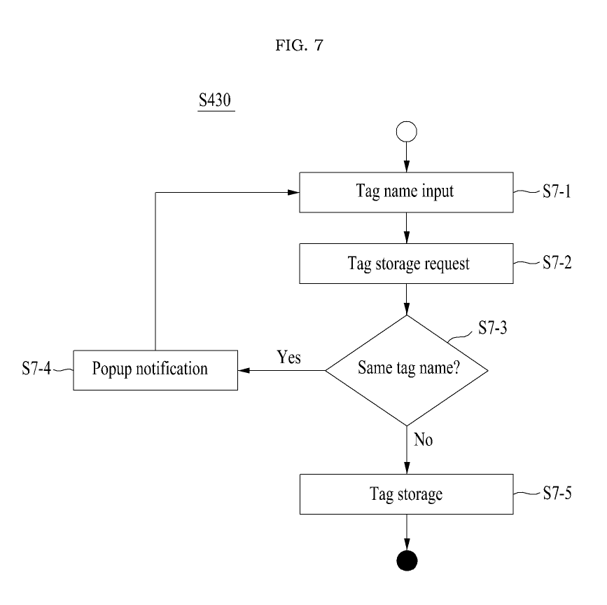

FIG. 7 is a flowchart illustrating an example of a tag storage method performed by the tag creator 320 according to at least one example embodiment. Operations S7-1 through S7-5 of FIG. 7 may be included in operation 5430 of FIG. 4 and thereby performed.

In operation S7-1, the tag creator 320 receives a tag name to be newly stored through a user input, in a text form.

In operation S7-2, the tag creator 320 makes a tag storage request for the tag name input in operation S7-1.

In operation S7-3, the tag creator 320 determines whether a same tag name as the requested tag name is present among pre-stored tags in response to the tag storage request.

In operation S7-4, when the same tag name is present among the pre-stored tags, the tag creator 320 provides a popup notifying a presence of the tag name and may request an input of a new tag name.

On the contrary, in operation S7-5, when the same tag name is absent among the pre-stored tags, the tag creator 320 stores the tag name input in operation S7-1, as a new tag name.

The tag input and storage process may be performed before or after performing a process of designating a partial playback section of a video for tagging.

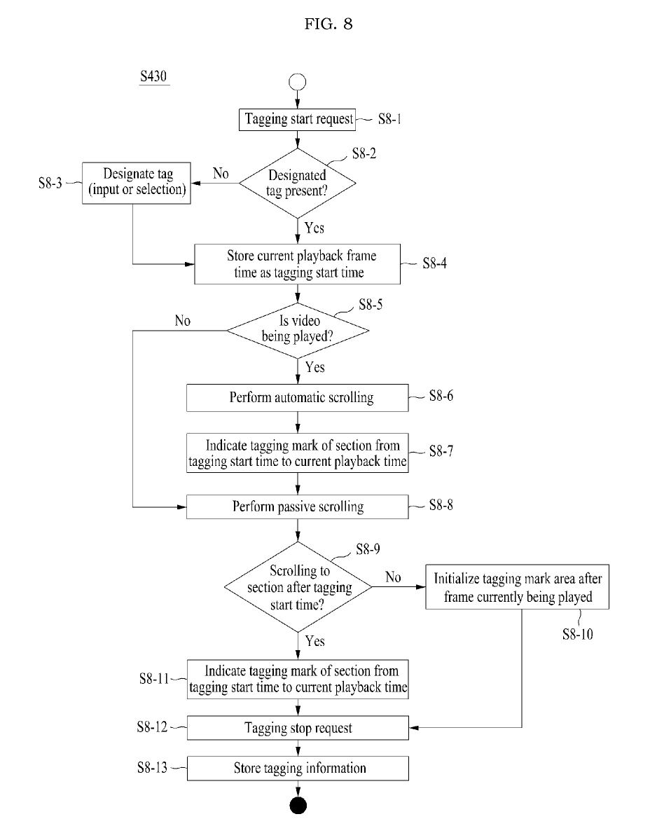

FIG. 8 is a flowchart illustrating an example of a tagging information creating method performed by the tag creator 320 according to at least one example embodiment. Operations S8-1 through S8-13 of FIG. 8 may be included in operation 5430 of FIG. 4 and thereby performed.

In operation S8-1, the tag creator 320 provides a tagging start menu with respect to a specific video in response to a user request. The tagging start menu may be displayed on a video playback screen on an electronic device such as the electronic device 110, for example, and the user may request a tagging start using the tagging start menu at a specific scene of a video while viewing the video on the video playback screen. For example, the reference point 611 marked on the representative image list 620 (shown in FIG. 6) may be configured as the tagging start menu. The reference point 611 may be configured in a toggle button form on which the tagging start menu and a tagging stop menu intersect.

In operation S8-2, the tag creator 320 determines whether a tag designated by the user is present in response to the tagging start request.

In operation S8-3, when the tag designated by the user is absent, the tag creator 320 provides a tag absence notification and requests a tag designation, for example, an input or a selection of a tag name.

Conversely, in operation S8-4, when the tag designated by the user is present, the tag creator 320 stores a current playback frame time of the video corresponding to a requested tagging start time as a tagging start time.

In operation S8-5, the tag creator 320 determines whether the video is being played.

In operation S8-6, the tag creator 320 sequentially connects and displays representative images for the respective frame extraction time intervals of the video on the video playback screen, and performs automatic scrolling on a representative image of a section corresponding to a current playback time of the video if the video is currently being played.

Depending on cases, the tag creator 320 may store a current playback frame time of the video as a tagging stop time, and may update the tagging stop time if playing of the video continues.

In operation S8-7, the tag creator 320 indicates a tagging mark of a section from a tagging start time to a current playback time on the video playback screen. For example, the tag creator 320 may indicate a tagging mark on an area from a tagging start time to a current playback time on a representative image list in which representative images for the respective frame extraction time intervals are sequentially connected.

In operation S8-8, if the user manipulates a playback time of the video, for example, if the user selects a representative image on the representative image list, the tag creator 320 performs passive scrolling to a representative image of a section corresponding to the manipulated playback time.

In operation S8-9, the tag creator 320 determines whether the passive scrolling relates to scrolling to a section after the tagging start time or scrolling to a section before the tagging start time.

In operation S8-10, when the passive scrolling is scrolling to the section before the tagging start time, the tag creator 320 may initialize a tagging mark area after a frame currently being played according to the scrolling.

Depending on cases, when the passive scrolling is scrolling to the section before the tagging start time, the tag creator 320 may store the tagging start time stored in operation S8-4 as the tagging stop time, and may store a time of a frame currently being played according to the scrolling as the tagging start time.

In operation S8-11, when the passive scrolling is scrolling to the section after the tagging start time, the tag creator 320 indicates a tagging mark of a section from the tagging start time stored in operation S8-4 to the time of the frame currently being played according to the scrolling on the video playback screen.

Depending on cases, when the passive scrolling is scrolling to the section after the tagging start time, the tag creator 320 may store the time of the frame currently being played time according to the scrolling as the tagging stop time.

In operation S8-12, the tag creator 320 provides a tagging stop menu in response to a user request. The tagging stop menu may be displayed on the video playback screen and the user may request a tagging stop using the tagging stop menu. For example, the reference point 611 marked on the representative image list 620 may be switched to the tagging stop menu during tagging. In this case, a tagging stop request may be input in response to a manipulation of the reference point 611.

In operation S8-13, in response to an input of the tagging stop request, the tag creator 320 stores, as tagging information, the tagging start time stored in operation S8-4 and the time of the frame currently being played, for example, the tagging stop time, which is a point in time at which the tagging stop request is input. A preview screen for a tagging section may be provided prior to storing the tagging information.

The tag creator 320 may perform tagging with respect to at least one partial playback section in the entire playback section of the video using a single tag by repeating operations S8-1 through S8-13 included in the tagging method.

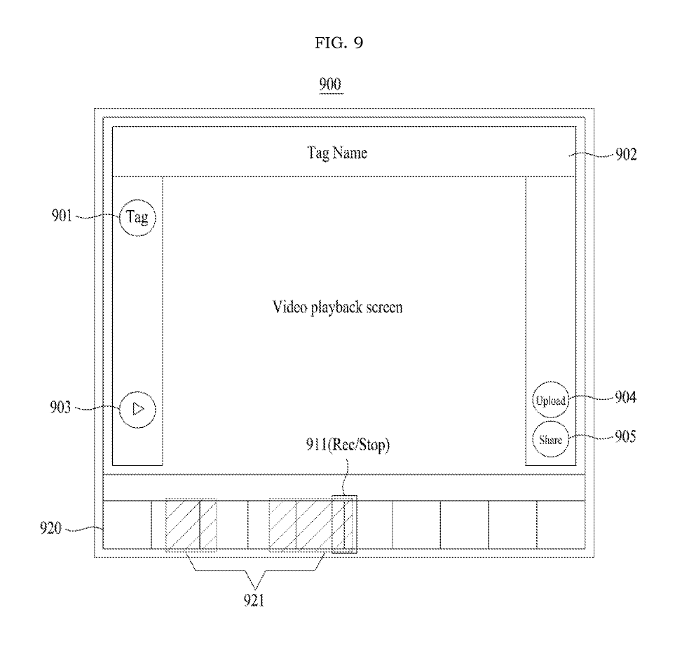

FIG. 9 illustrates an example of a user interface screen for creating tagging information of a video according to at least one example embodiment.

Referring to FIG. 9, a user interface screen 900 may be provided as a video playback screen on an electronic device such as the electronic device 110, for example. The video playback screen may include a representative image list 920. The representative image list 920 may include representative images extracted at frame extraction time intervals set to a video. A reference point 911 indicating a current playback time of the video may be marked on the representative image list 920. The representative image list 920 may serve as a thumbnail progress bar, such as a prototype screen. For example, the reference point 911 may be fixed at the center of the representative image list 920. Representative images included in the representative image list 920 may be automatically scrolled to fit the reference point 911 and a current playback time of the video may be indicated according to playing of the video. Auto-scrolling may be performed to locate a first representative image at the reference point 911 at an initial stage, and to subsequently locate a representative image of a section corresponding to the current playback time of the video at the reference point 911 in a subsequent stage.

The user interface screen 900 may include a menu list for creating tagging information.

A ‘Tag’ menu 901 provides a list of tags stored by newly inputting a tag name, or stored in advance. A user may designate a specific tag by newly inputting a tag name or selecting a single tag from the tag list using the Tag′ menu 901. The tag name input from the user may be displayed on a preset (or, alternatively, desired) area 902 of the user interface screen 900.

The user interface screen 900 may provide a ‘Rec’ menu for a tagging start request and a ‘Stop’ menu for a tagging stop request. For example, the reference point 911 may be provided in a toggle button type to replace the ‘Rec’ menu and the ‘Stop’ menu. The user may request a tagging start at a frame currently being played in correspondence to the reference point 911 by manipulating the reference point 911 in a ‘Rec’ menu state. Once the ‘Rec’ menu is selected, a corresponding partial playback section of the video may enter a tag recording state in which tag recording is allowed. The user may request a tagging stop at a frame being currently played in correspondence to the reference point 911 by manipulating the reference point 911 in a ‘Stop’ menu state. Once the ‘Stop’ menu is selected, a corresponding partial playback section may enter a tag recording release state and a corresponding partial playback section, that is, a tagging area, of the video may be recorded in the tag name designated by the user.

A ‘ [symbol] ’ menu 903 is used to request playing of the video. The representative image list 920 may be scrolled to fit a current playback time of the video in synchronization therewith. If the video is played using the ‘ [symbol] ’ menu 903 and is in the tag recording state in response to a user selection on the ‘Rec’ menu, the video may be played and the tagging may be automatically performed. The ‘ [symbol] ’ menu 903 may be provided in a ‘stop’ button and toggle form in order to stop playing of the video. In response to a user selection on the ‘ [symbol] ’ menu 903, the corresponding menu may be switched to the ‘stop’ menu.

An area that is tagged as the tag recording state corresponding to the selection of the ‘Rec’ menu may be displayed on the representative image list 920. For example, a tagging mark 921 may be marked at each section corresponding to a tagging area in the representative image list 920. The user may recognize the tagging area through the tagging mark 921. A function of initializing or deleting tagging of a corresponding tagging area using the tagging mark 921 may be provided. For example, a menu for deleting tagging of a corresponding area may be provided in response to a selection of the tagging mark 921 using, for example, a long-touch, a double-click, and the like on the user interface screen 900.

An ‘Upload’ menu 904 is used to upload tagging information to the server 150. Once tagging of a partial playback section of the video is completed, tagging information may be uploaded to the server 150 using the ‘Upload’ menu 904. For example, in response to the user manipulating the ‘Upload’ menu 904, a preview screen for a corresponding tagging section may be provided prior to uploading the tagging information. In response to an input of a confirmation request through the preview screen, the tagging information may be uploaded to the server 150. The preview screen may be a screen for verifying a tagged video playback section. A tagging list connected to a tag designated by the user may be displayed on the preview screen. A video playback section included in the tagging list may be played. The user interface screen 900 may further include a ‘Share’ menu for sharing tagging information with another user through an SNS.

Information about the video may be managed as a data configuration shown in Table 1, and information about the tag may be managed as a data configuration shown in Table 2.

TABLE 1

| Video ID | |
|---|---|
| (unique value) | Video Name |
| V1 | My love from the star |
| V2 | The thieves |

TABLE 2

| Tag ID | |
|---|---|
| (unique value) | Tag Name |
| T1 | Gianna Jun |
| T2 | Chunsongi fashion |

Tagging data, that is, tagging information, in which a playback section of the video is connected to a tag designated by the user may be configured as a data configuration shown in Table 3.

TABLE 3

| Tagging | | | | |
|---|---|---|---|---|
| ID | Video ID | Tag ID | Play start | |
| (unique | (unique | (unique | time | Play end time |
| value) | value) | value) | (hh:mm:ss) | (hh:mm:ss) |
| VT1 | V1 | T1 | 00:10:10 | 00:12:00 |
| VT2 | V1 | T1 | 00:15:30 | 00:18:10 |
| VT3 | V1 | T2 | 00:10:15 | 00:11:00 |
| VT4 | V1 | T2 | 00:15:30 | 00:16:00 |
| VT5 | V2 | T2 | 01:00:00 | 01:10:00 |
| VT6 | V2 | T2 | 01:30:10 | 01:35:30 |

Tagging information may have a unique ID value for each tagged playback section. For example, if the user tags ‘Gianna Jun’ T1 to a playback section corresponding to 00:10:10-00:12:00 in the video ‘My love from the star’ V1, a tagging ID VT1 of the corresponding playback section may be created, and the video ‘My love from the star’ V1, the tag ‘ Gianna Jun’ T1, the play start time 00:10:10, and the play end time 00:12:00 may be stored in association with the tagging ID VT1. If the user tags ‘Chunsongi fashion’ T2 to a playback section corresponding to 01:00:00-01:10:00 in the video ‘The thieves’ V2, a tagging ID VT5 of the corresponding playback section may be created and the video ‘The thieves’ V2, ‘Chunsongi fashion’ T2, the play start time 01:00:00, and the play end time 01:10:00 may be stored in association with the tagging ID VT5.

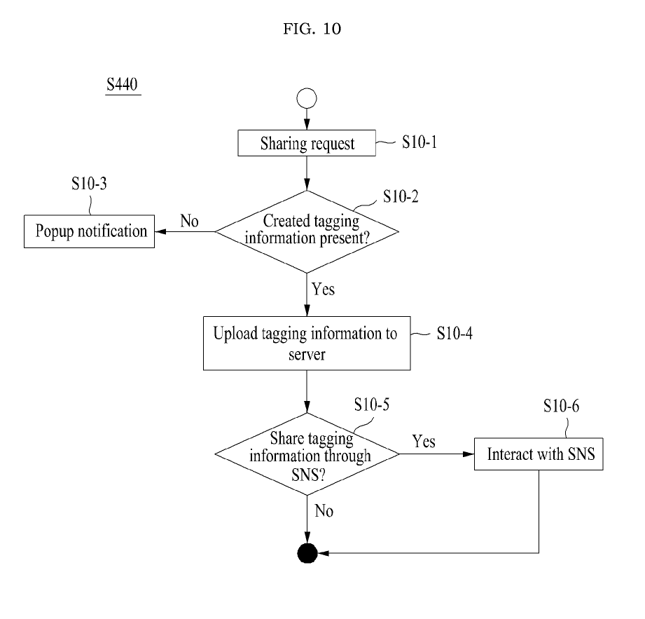

FIG. 10 is a flowchart illustrating an example of a tagging information sharing method performed at the tag manager 330 according to at least one example embodiment. Operations S10-1 through S10-6 of FIG. 10 may be included in operation 5440 of FIG. 4 and thereby performed.

In operation S10-1, the tag manager 330 provides a menu for sharing tagging information in response to a user request.

In operation S10-2, the tag manager 330 determines whether created tagging information is present.

In operation S10-3, when the created tagging information is absent, the tag manager 330 may provide a popup notifying an absence of tagging information to be shared.

In operation S10-4, when at least one set of created tagging information is present, the tag manager 330 uploads the created tagging information to the server 150.

In operations S10-5 and S10-6, if the user desires to share the created tagging information with another user through an SNS, the tag manager 330 interacts with the SNS to transfer the tagging information to the other user.

The tagging information sharing method may be selectively performed or may be omitted. Alternatively, only a portion of the tagging information sharing method may be omitted. For example, the tagging information may be shared by skipping a process of uploading tagging information to the server 150 in the tagging information sharing method, and by directly interacting with the SNS.

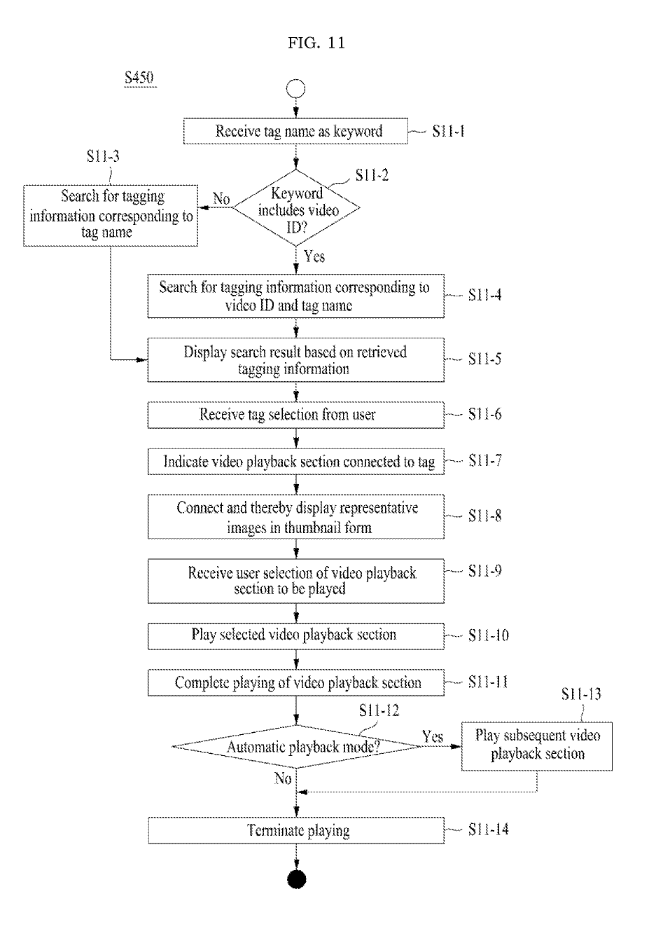

FIG. 11 is a flowchart illustrating an example of a tag search and play method performed by the tag searcher 340 according to at least one example embodiment. Operations S11-1 through S11-14 of FIG. 11 may be included in operation 5450 and thereby performed.

In operation S11-1, the tag searcher 340 receives a tag name desired by a user as a keyword. Here, if the user is to search for a tag name from a specific video, the tag searcher 340 may receive a keyword that includes a video ID.

In operation S11-2, the tag searcher 340 determines whether the keyword includes the video ID.

In operation S11-3, when the user is to search for the tag name without specifying the video, that is, when the keyword does not include the video ID, the tag searcher 340 searches for tagging information corresponding to the tag name with respect to all of the videos.

In operation S11-4, when the user is to search for the tag name from the specific video, that is, when the keyword includes the video ID, the tag searcher 340 searches for tagging information corresponding to the video ID and the tag name.

In operation S11-5, the tag searcher 340 displays a search result based on the tagging information retrieved in operation S11-3 or in operation S11-4. The search result may be provided as a list of video names, tag names, tagging data counts, etc.

In operation S11-6, the tag searcher 340 receives a user selection on a specific tag from among tags included in the search result.

In operation S11-7, the tag searcher 340 indicates a video playback section, for example, a tagging section connected to the specific tag selected in operation S11-6.

In operation S11-8, the tag searcher 340 extracts representative images for the respective video playback sections and connects and displays the extracted representative images in a thumbnail form.

In operation S11-9, the tag searcher 340 receives a user selection on a video playback section to be played among video playback sections connected to the specific tag.

In operation S11-10, the tag searcher 340 plays the video playback section selected in operation S11-9.

Once playing of the video playback section selected in operation S11-9 is completed, the tag searcher 340 determines whether a current mode is an automatic playback mode in operations S11-11 and S11-12.

In operation S11-13, the tag searcher 340 plays a subsequent video playback section in order of playback times of the video playback sections connected to the specific tag in the automatic playback mode.

Otherwise, in operation S11-14, the tag searcher 340 terminates playing of the video playback sections connected to the specific tag.

The tagging information search method may be selectively performed or may be omitted. Alternatively, only a portion of the tagging information search method may be omitted.

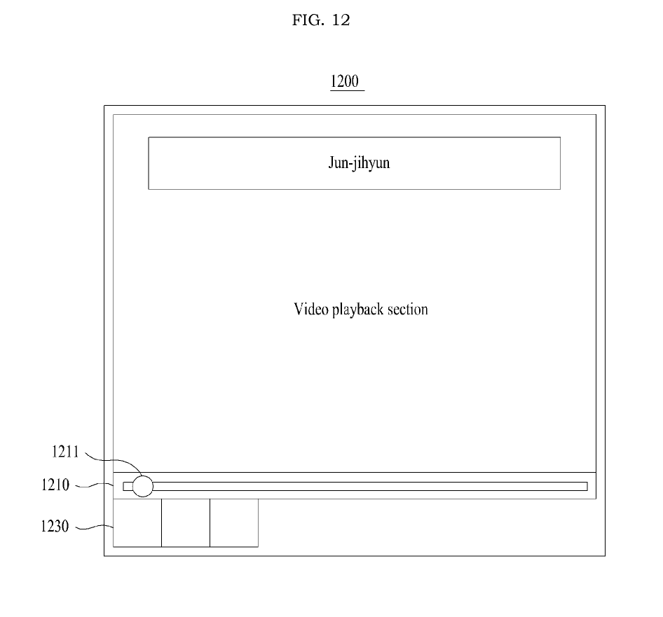

FIG. 12 illustrates an example of a tag search result screen on any of the electronic devices 110, 120, 130, 140 according to at least one example embodiment.

For example, referring to FIG. 12, a tag search result screen 1200 may provide a search result of a tag ‘Gianna Jun’, and may display a video playback section list 1230 tagged with ‘Gianna Jun’. Here, in the video playback section list 1230, representative images for the respective playback sections are connected and thereby displayed in a thumbnail form. For example, the first frame of a video playback section may be determined as a representative image. Video playback sections included in the video playback section list 1230 may be automatically played and output on the tag search result screen 1200 in a sequential order. In response to a selection of a specific thumbnail on the video playback section list 1230, a video playback section corresponding to the selected thumbnail may be played and output on the tag search result screen 1200. A progress bar 1210 may be displayed on the tag search result screen 1200. The progress bar 1210 may include a reference point 1211 indicating a current playback time of the video. The video playback section list 1230 may not serve as a progress bar on the tag search result screen 1200. In this case, a separate progress bar may be provided. That is, it is possible to search for and seek a video playback section using the progress bar 1210 or the video playback section list 1230.

As described above, in a search environment using a tag, it is possible to search for a specific tag and to retrieve a plurality of video playback sections tagged with the specific tag at a time.

The video playback screen 600, the user interface screen 900 and the tag search result screen 1200 of FIGS. 6, 9, and 12 are provided as examples only to help understanding and the present disclosure is not limited thereto and a configuration, an order, etc., of a screen may be variously modified.

According to some example embodiments, it is possible to easily and simply connect a tag to a portion of scenes that constitute a video. Also, according to some example embodiments, it is possible to connect an identifiable name to a portion of scenes in a video as a tag, and to search for a desired scene, thereby saving a time and effort used for retrieving the scene. Also, according to some example embodiments, it is possible to provide a highlight scene of a video using a tag that is logical information, instead of providing a highlight image using a segmental image, thereby saving server storage space. Also, according to some example embodiments, it is possible to quickly share a desired scene in a video by connecting the scene to be shared to a tag and by uploading the scene. Further, it is possible to effectively share a plurality of scenes by sharing a single tag.

The foregoing description has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The status of the claims is as follows:

1. A video tagging method, implemented in a computer, for tagging a video displayed on a video playback screen, the method comprising:
displaying representative images corresponding to a plurality of playback sections of the video, on the video playback screen;
creating tagging information corresponding to a tag designated by a user by storing a tagging start time indicating a video playback time corresponding to a playback section of the video at which a tagging start request is input by the user, and a tagging stop time indicating a video playback time corresponding to a playback section of the video at which a tagging stop request is input, and by generating a tagging mark indicating the representative images corresponding to the playback sections from the tagging start time to the tagging stop time; and
storing the tagging information without storing the playback sections from the tagging start time to the tagging stop time.

2. The method of claim 1, wherein the creating of the tagging information further comprises receiving an input or a selection of a tag name in a text form and designating the tag.

3. (canceled)

4. The method of claim 1, further comprising:
displaying a menu list including a menu for designating the tag, a menu for the tagging start request, and a menu for the tagging stop request on the video playback screen on which the video is displayed.

5. (canceled)

6. The method of claim 1, further comprising:
providing a function of initializing or deleting tagging of the playback section from the tagging start time to the tagging stop time using the tagging mark.

7. The method of claim 1, wherein the storing comprises storing the tagging information in a local area of the computer or uploading the tagging information to a server that interacts with the computer.

8. The method of claim 1, further comprising:
sharing the tagging information with another user through a server that interacts with the computer.

9. The method of claim 1, further comprising:
searching for tagging information corresponding to the tag in response to a search request using the tag, and providing the playback section connected to the tag as a search result.

10. The method of claim 9, wherein the providing of the playback section comprises specifying a video that is a search target and searching for the playback section connected to the tag in response to the search request.

11. A non-transitory computer-readable medium storing a computer program to implement a video tagging method for tagging a video displayed on a video playback screen, wherein the video tagging method comprises:
displaying representative images corresponding to a plurality of playback sections of the video, on the video playback screen;
creating tagging information corresponding to a tag designated by a user by storing a tagging start time indicating a video playback time corresponding to a playback section of the video at which a tagging start request is input by the user, and a tagging stop time indicating a video playback time corresponding to a playback section of the video at which a tagging stop request is input and by generating a tagging mark indicating the representative images corresponding to the playback sections from the tagging start time to the tagging stop time; and
storing the tagging information without storing the playback sections from the tagging start time to the tagging stop time.

12. A video tagging system, configured as a computer, for tagging a video displayed on a video playback screen, the system comprising:
a memory to which at least one program for tagging the video is loaded; and
at least one processor,
wherein, under control of the program, the at least one processor is configured to perform:
a process of creating tagging information corresponding to a tag designated by a user by storing a tagging start time indicating a video playback time corresponding to a playback section of the video at which a tagging start request is input by the user, and a tagging stop time indicating a video playback time corresponding to a playback section of the video at which a tagging stop request is input, and by generating a tagging mark indicating the representative images corresponding to the playback sections from the tagging start time to the tagging stop time; and
a process of storing the tagging information without storing the playback sections from the tagging start time to the tagging stop time.

13. The system of claim 12, wherein the creation process comprises receiving an input or a selection of a tag name in a text form and to designate the tag.

14. (canceled)

15. (canceled)

16. The system of claim 12, wherein the at least one processor further performs providing a function of initializing or deleting tagging of the playback section from the tagging start time to the tagging stop time using the tagging mark.

17. The system of claim 12, wherein the storage process comprises storing the tagging information in a local area of the computer or uploading the tagging information to a server that interacts with the computer.

18. The system of claim 12, wherein the at least one processor further performs sharing the tagging information with another user through a server that interacts with the computer.

19. The system of claim 12, wherein the at least one processor further performs searching for tagging information corresponding to the tag in response to a search request using the tag, and providing the playback section connected to the tag as a search result.

20. The system of claim 19, wherein the providing comprises specifying a video that is a search target and searching for the playback section connected to the tag in response to the search request.
